(19) United States
(12) Patent Application Publication
(10) Pub. No.: US 2012/0005457 A1
(43) Pub. Date: Jan. 5, 2012

(54) USING SOFTWARE-CONTROLLED SMT PRIORITY TO OPTIMIZE DATA PREFETCH WITH ASSIST THREAD

(75) Inventors: Tong Chen, Yorktown Heights, NY (US); Yaoqing Gao, North York (CA)

(73) Assignee: International Business Machines Corporation, Armonk, NY (US)

(21) Appl. No.: 12/828,326

(22) Filed: Jul. 1, 2010

(51) Int. Cl. G06F 9/38; G06F 9/312

(52) U.S. Cl. 712/207; 712/E09.033; 712/E09.055

(57) ABSTRACT

A method for optimizing data prefetch using assist threads is disclosed herein. In one embodiment, such a method includes executing a main application thread substantially simultaneously with an assist thread. The assist thread is configured to prefetch data for the main application thread. The method further includes monitoring, at runtime, the progress of the main application thread and the assist thread. Depending on the progress of the main application thread and the assist thread, the method dynamically adjusts, at runtime, the priority of the main application thread, the priority of the assist thread, or both. This will help to ensure that the progress of the main application thread and the assist thread are substantially synchronized while executing so that the assist thread increases the performance of the main application thread as initially intended. A corresponding computer program product, apparatus, and system and also disclosed herein.

### BACKGROUND

1. Field of the Invention

This invention relates to apparatus and methods for optimizing data prefetch using assist threads.

2. Background of the Invention

Software-based data prefetch is a powerful technique to address the increasing latency gap between processors and memory subsystems. In order to precisely and efficiently prefetch data for an application thread (to reduce cache misses and the resulting latency), one popular solution is to generate an assist thread to prefetch data for a main application thread. In some systems, the main application thread and the assist thread of an application run simultaneously on the same processor core (i.e., referred to herein as “simultaneous multithreading,” or “SMT”) to fully utilize the data prefetching feature. However, just like any two unrelated threads executing simultaneously on the processor core, the main application thread and the assist thread may contend for resources in the processor.

Existing hardware typically provides several mechanisms to adjust the resource usage among SMT threads. These mechanisms are typically targeted at the throughput of the system and are not aware of or able to take into account the semantics or relationship between the two simultaneously executing threads. In the case of an assist thread running in association with a main application thread, the two threads are intended to work cooperatively to increase the efficiency and performance of the application. Because existing hardware is unaware of this cooperative relationship, the hardware is unable to take advantage of this relationship to more effectively assign resources in the processor to the two threads.

In view of the foregoing, what are needed are apparatus and methods to more effectively assign resources to a main application thread and an assist thread configured to prefetch data for the main application thread. More specifically, apparatus and methods are needed to use software-controlled priority to more dynamically assign, at runtime, resources to the main application thread and the assist thread. Further needed are apparatus and methods to monitor the progress of the main application thread and the assist thread so that the progress of the two threads can be substantially synchronized.

### SUMMARY

The invention has been developed in response to the present state of the art and, in particular, in response to the problems and needs in the art that have not yet been fully solved by currently available apparatus and methods. Accordingly, the invention has been developed to provide apparatus and methods for optimizing data prefetch using assist threads. The features and advantages of the invention will become more fully apparent from the following description and appended claims, or may be learned by practice of the invention as set forth hereinafter.

Consistent with the foregoing, a method for optimizing data prefetch using assist threads is disclosed herein. In one embodiment, such a method includes executing a main application thread substantially simultaneously with an assist thread. The assist thread is configured to prefetch data for the main application thread. The method further includes monitoring, at runtime, the progress of the main application thread and the assist thread. Depending on the progress of the main application thread and the assist thread, the method dynamically adjusts, at runtime, the priority of the main application thread, the priority of the assist thread, or both. This will help to ensure that the progress of the main application thread and the assist thread are substantially synchronized during execution so that the assist thread increases the performance of the main application thread as initially intended.

A corresponding system is also disclosed and claimed herein.

In another embodiment of the invention, a computer program product for optimizing data prefetch using assist threads is disclosed herein. The computer program product includes a computer-usable storage medium having computer-usable program code embodied therein. In one embodiment, the computer-usable program code includes program code to generate an assist thread configured to prefetch data for a main application thread. The computer-usable program code further includes program code to embed, within one or more of the assist thread and the main application thread, instructions to monitor the progress of the threads while they are executing. The computer-usable program code further includes program code to embed, within one or more of the assist thread and the main application thread, instructions to dynamically adjust, at runtime, the priority of the main application thread, the assist thread, or both. This will help to ensure that the progress of the main application thread and the assist thread stay substantially synchronized.

A corresponding apparatus is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a flow diagram showing one embodiment of a method for monitoring the progress of a main application thread;

FIG. 2 is a flow diagram showing one embodiment of a method for monitoring the progress of an assist thread, as well as loosely synchronizing the assist thread with the main application thread;

FIG. 3 is a flow diagram showing one embodiment of a method for monitoring the progress and adjusting the priority of a main application thread;

FIG. 4 is a flow diagram showing one embodiment of a method for monitoring the progress and adjusting the priority of an assist thread to loosely synchronize the assist thread with the main application thread;

FIG. 5 is a table showing one example of various different effective priorities for the main application thread and assist thread combined;

FIG. 6 is a diagram showing various heuristics rules that may be used to adjust the priority of the main application thread and the assist thread;

FIG. 7 is a bar graph showing the results of experiments conducted to determine the performance increase with software-based priority control built into the main application thread and the assist thread, compared to the performance without built-in software-based priority control; and

FIG. 8 is a high-level block diagram of one embodiment of an apparatus (e.g., a compiler) used to generate an assist thread for a main application thread, as well as embed software-based priority control instructions into the assist thread and main application thread.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, may be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

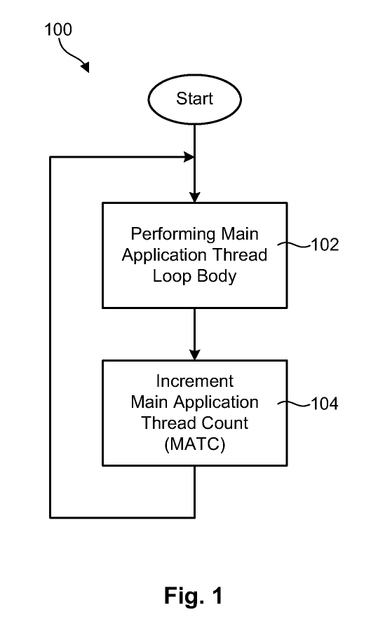

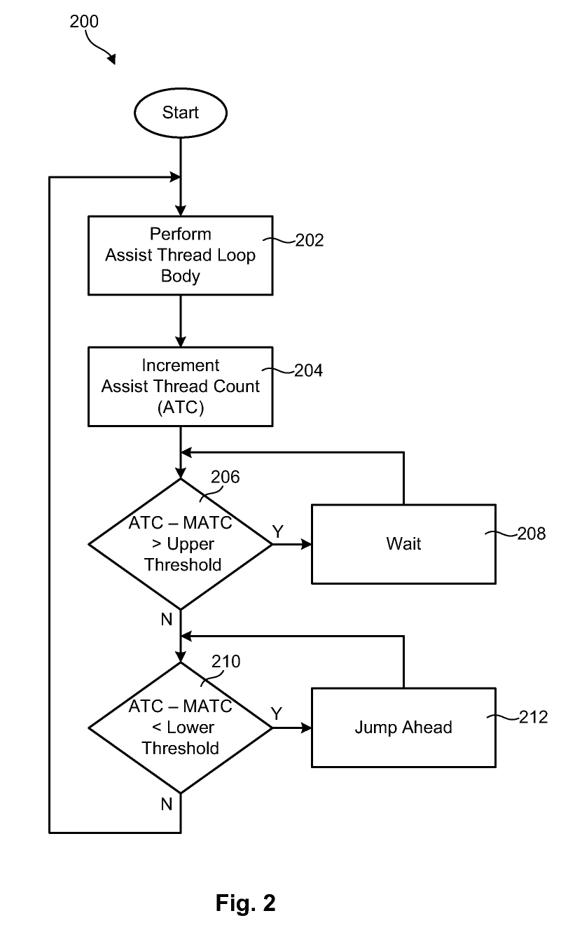

Referring generally to FIGS. 1 and 2, in order for an assist thread to efficiently prefetch data (i.e., place needed data in a cache) for a main application thread, the assist thread needs to be loosely (i.e., substantially) synchronized with the main application thread. To provide this loose synchronization, techniques are needed to determine the distance by which the assist thread leads the main application thread and vice versa. Additional techniques are needed to control this distance. If the assist thread is too slow and falls too far behind the main application thread, the assist thread may not be able to prefetch data in time for it to be useful to the main application thread. This can actually reduce performance since the assist thread will consume cycles on the processor core without performing any useful work. Thus, techniques are needed to ensure that the assist thread does not fall behind the main application thread by too great a distance.

On the other hand, if the assist thread is too fast and leads the main application thread by too great a distance, the assist thread may prefetch data too early. In certain cases, this may unnecessarily displace useful data in the cache, resulting in more cache misses in the main application thread. In other cases, data that is prefetched too early by the assist thread may already be displaced from the cache by the time it is needed by the main application thread. Thus, techniques are needed to ensure that the assist thread does not lead the main application thread by too great a distance.

FIG. 1 is a flow diagram showing one embodiment of a method 100 for monitoring the progress of a main application thread. This method 100 may be implemented within the main application thread. FIG. 2 is a flow diagram showing one embodiment of a method 200 for monitoring the progress of an assist thread, as well as loosely synchronizing the assist thread with the main application thread. This method 200 may be implemented within the assist thread. In general, counters are inserted into loops within the assist thread and the main application thread to monitor the progress of each of the threads. The count values in these threads are periodically compared to determine if the assist thread leads or trails the main application thread by too great a distance. If the assist thread leads the main application thread by too great a distance, the distance is reduced by causing the assist thread to wait for the main application thread to catch up. On the other hand, if the assist thread trails the main application thread by too great a distance, the distance is reduced by causing the assist thread to jump ahead to catch up with the main application thread.

As shown in FIG. 1, a method 100 may include performing 102 a main application thread loop body. Each time the main application thread loop body is performed, the method 100 increments 104 a main application thread count (MATC). This MATC may be stored in shared memory so that it can be accessed by the assist thread. As shown in FIG. 2, a method 200 may include performing 202 an assist thread loop body. Each time the assist thread loop body is performed 202, the method 200 increments 204 an assist thread count (ATC). Upon incrementing the ATC, the method 200 calculates the difference between the ATC and the MATC to determine 206 whether the distance between the ATC and MATC is greater than an upper threshold. If the distance exceeds the upper threshold, this indicates that the assist thread is leading the main application thread by too great a distance. In such a case, the assist thread waits 208 (such as by ceasing to execute or executing NOP commands) for a specified amount of time or a number of processor cycles. The method 200 then re-compares 206 the ATC to the MATC and repeats the above-described process until the distance between the assist thread and the main application thread is less than the upper threshold.

In the event the distance between the assist thread and the main application thread is not greater than the upper threshold, the method 200 determines 210 whether the distance between the ATC and the MATC is less than a lower threshold. If the distance is less than the lower threshold, this indicates that the assist thread is trailing the main application thread by too great a distance. In such a case, the assist thread jumps ahead 212 a specified amount in order to catch up with the main application thread. The method 200 then re-compares 210 the ATC to the MATC and repeats the above-described process until the distance between the assist thread and the main application thread is greater than the lower threshold. In this way, the method 200 dynamically and continuously synchronizes the assist thread and the main application thread while the two threads are executing. Once the assist thread and the main application thread are substantially synchronized, the method 200 performs 202 the assist thread loop body, increments 204 the assist thread count, and repeats the remaining steps as previously described.

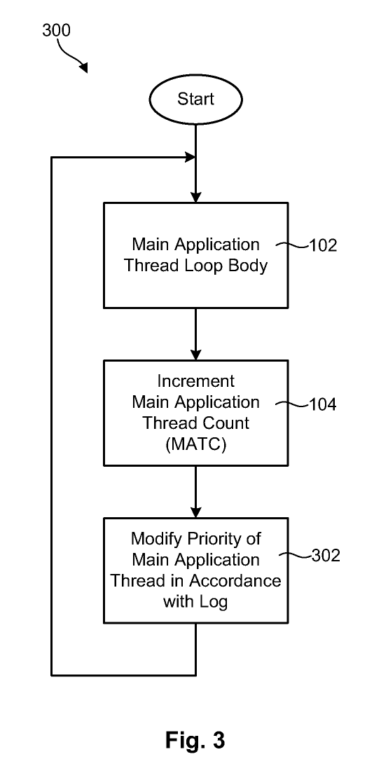

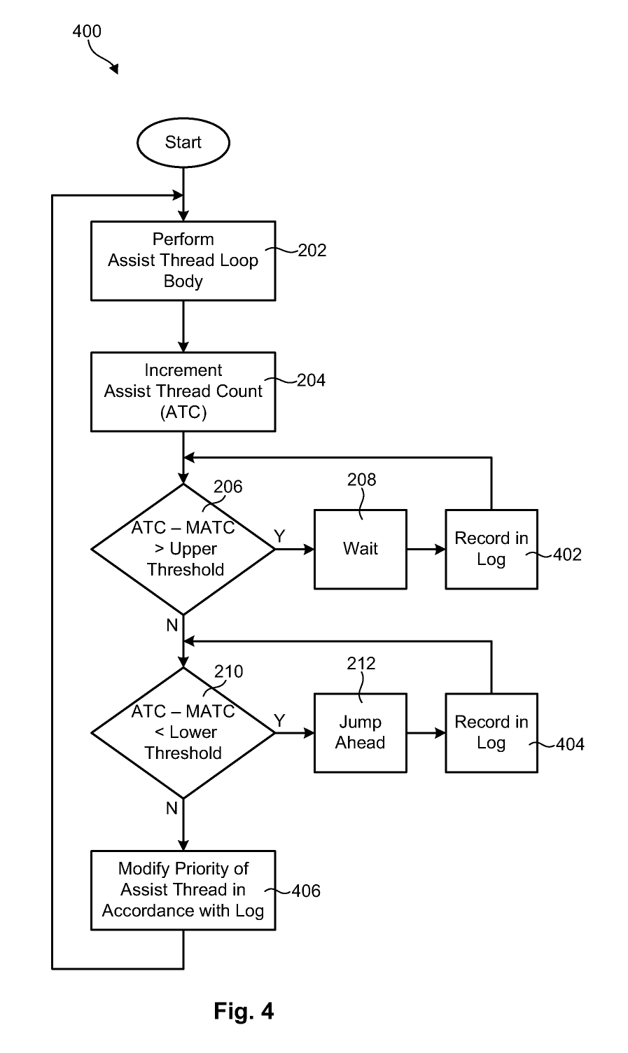

Referring generally to FIGS. 3 and 4, in selected embodiments, software-based priority may be used to improve the methods 100, 200 illustrated in FIGS. 1 and 2. More specifically, software-based priority may be used to dynamically adjust the priority of the assist thread and the main application thread (based on their runtime behavior) and keep the two threads substantially synchronized without requiring the assist thread to wait 208 or jump ahead 212 as often or as much. This may reduce the overhead required to keep the assist thread and main application thread synchronized.

In the illustrated embodiment, a log is used to record the numbers of times, amount, and/or frequency that the assist thread waits and/or jumps ahead to stay synchronized with the main application thread. This information may indicate whether the assist thread is too fast, too slow, or within a reasonable range compared to the main application thread. Using this information, the priority of the assist thread and main application thread may be adjusted to regulate the speed with which they progress relative to one another. This keeps the threads more closely synchronized and reduces the need for the assist thread (or main application thread) to wait or jump ahead as often or as much.

For example, as shown in FIG. 3, a method 300 may include performing 102 a main application thread loop body. Each time the main application thread loop body is performed 102, the method 300 increments 104 a main application thread count (MATC). The method 300 also modifies 302 the priority of the main application thread in accordance with information stored in the log. These method steps may be repeated as long as the main application thread loop continues to execute. In this way, the method 300 continuously and dynamically updates the priority of the main application thread.

Similarly, as shown in FIG. 4, the method 400 is similar to that illustrated in FIG. 2 except that each time the assist thread waits 208, information is recorded 402 in a log to indicate that the assist thread waited for the main application thread to catch up. Similarly, each time the assist thread jumps ahead 212, information is recorded 404 in a log to indicate that the assist thread jumped ahead to catch up to the main application thread. Once the method 400 determines 206, 210 that the distance between the assist thread and the main application thread is less than the upper threshold, and greater than the lower threshold, the method 400 modifies 406 the priority of the assist thread in accordance with the information stored in the log. In this way, the methods 300, 400 dynamically and continuously update the priority of the assist thread and/or main application thread to ensure that the threads execute at the appropriate relative speeds and thereby remain loosely synchronized.

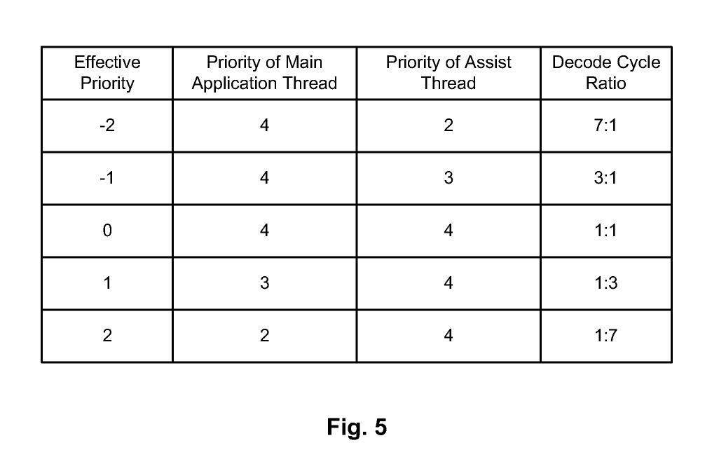

Referring to FIG. 5, software-controlled priority for simultaneous multithreading (SMT) determines how decode cycles are assigned among the SMT threads. The priority may be set by special instructions and may be carried out by hardware in the decode stage. In general, a thread with a higher priority will be assigned more decode cycles. This is a particular feature implemented in PowerPC architectures (although embodiments of the invention are not limited to PowerPC architectures) to provide software with more control over SMT resource usage.

In PowerPC architectures, the assignment of decode cycles is determined by the difference of the priority between the two SMT threads. The assignment of the decode cycles changes exponentially with the change of the priority. For example, assume the priority of the main application thread and the assist thread is p_mt and p_at, respectively. If the priority of the main application thread is higher than that of the assist thread, the main application thread will be assigned 2*p_mt−p_at+1 decode cycles while the assist thread will be assigned 1 decode cycle. Similarly, if the priority of the assist thread is higher than that of the main application thread, the assist thread will be assigned 2*p_at−p_mt+1 decode cycles while the main thread will be assigned 1 decode cycle. To more effectively synchronize the assist thread and the main application thread, the difference between the priority of the application thread and the assist thread is what matters.

The software-controlled priority for Power6 microprocessors range from 0 to 7, where 0 (the lowest priority) indicates the thread is switched off and 7 (the highest priority) indicates the thread is running in single thread (ST) mode with the other SMT threads switched off. Among all eight priorities, user software can only set priorities 2, 3, and 4. The other priorities require supervisor or even hypervisor privilege. The software-controlled priority can be set by issuing an “or” instruction in a special format. For example, the instruction “or 1, 1, 1” sets the priority to 2. For user convenience, these special instructions may be defined with macros. The instructions to set the priorities to 2, 3, and 4 may be respectively defined as smt_low_priority( ), smt_median_priority( ), and smt_normal_priority( ).

In the approach described hereinafter, priorities 2, 3, and 4 are exclusively used so that the techniques described herein can be utilized by ordinary users. When priorities 2, 3, and 4 are used exclusively, five different effective priorities may be achieved for the main application thread and the assist thread combined, as shown in FIG. 5. The priorities for the main application thread and assist thread are varied between 2 and 4. The effective priorities are denoted by integers −2 to 2, from low to high from the point of view of the assist thread. The decode cycle ratio for the threads is also listed for each of the effective priorities.

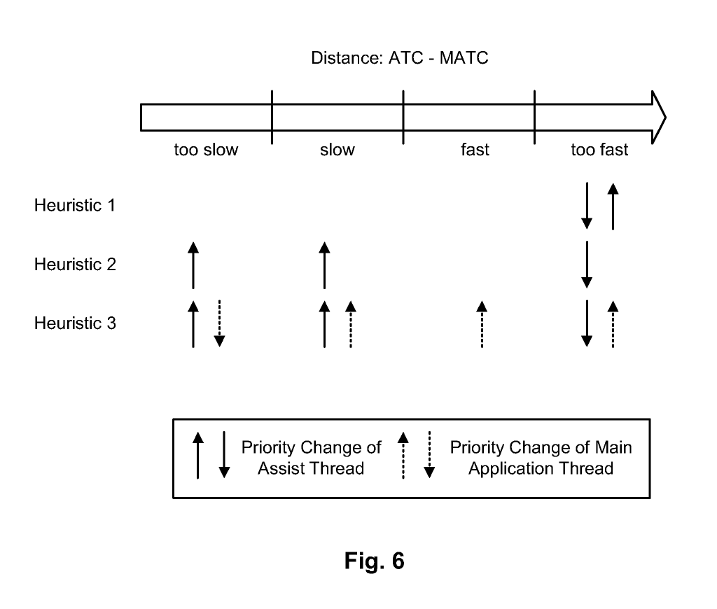

Referring to FIG. 6, a diagram showing various heuristics rules that may be used to adjust the priority of the main application thread and the assist thread (at steps 302 and 406, for example) is illustrated. FIG. 6 shows how the priority of the main application thread and the assist thread may be modified for three different heuristic rules as the distance between the main application thread and the assist thread varies. These heuristic rules are presented only by way of example and are not intended to be limiting. The first simple heuristic rule (“Heuristic 1”) is to lower the effective priority to −2 when the assist thread is waiting 208 and restore the effective priority to 0 when the waiting 208 finishes. This heuristic is quite safe since only the waiting step 208 is executed slower. In fact, the original purpose for software-controlled priority is to optimize such busy waiting 208.

The second heuristic rule (“Heuristic 2”) is based on Heuristic 1 except that it is more aggressive. The priority is lowered before the waiting step 208, but will not be restored until the assist thread is determined to be slower. In this way, some of the prefetch related operations in the assist thread may be executed at a lower priority and the main application thread gains additional resources. Heuristics 1 and 2 can be implemented in an efficient manner because they only adjust the priority of the assist thread. However, they can not achieve effective priorities 1 and 2 (as shown in FIG. 5) since they do not adjust the priority of the main application thread.

The third heuristic rule (“Heuristic 3”) is designed to achieve effective priorities 1 and 2 based on the operation of the second heuristic rule. In Heuristic 3, the assist thread may set a global flag when it determines that it is too slow. Conversely, the assist thread may clear the flag when it determines that it is not too slow. When the main application thread sees that this flag is set, the main application thread may be configured to lower its own priority (as illustrated in FIG. 3, for example). In this way, Heuristic 3 is able to utilize the whole range of effective priorities, as illustrated in FIG. 5. However, caution should be used when using Heuristic 3 since it may cause the main application thread to execute slower and could significantly degrade performance. Thus, when using Heuristic 3, it may be wise to lower the main application thread's priority infrequently and, when lowered, restore it promptly.

In order to fine tune the heuristics, in certain embodiments, the progress of the assist thread may be classified as slow or fast when it is actually not too slow or too fast in the progress control. The boundary point to distinguish between slow and fast may be a parameter in the heuristics. In the illustrated example (as shown in FIG. 6), the middle point between too slow and too fast is used. The actions taken by the heuristics are summarized in FIG. 6. The actions in Heuristic 3 for lowering and increasing the priority of the main application thread and assist thread may not be symmetric since a more conservative approach may be taken when lowering the main application thread's priority.

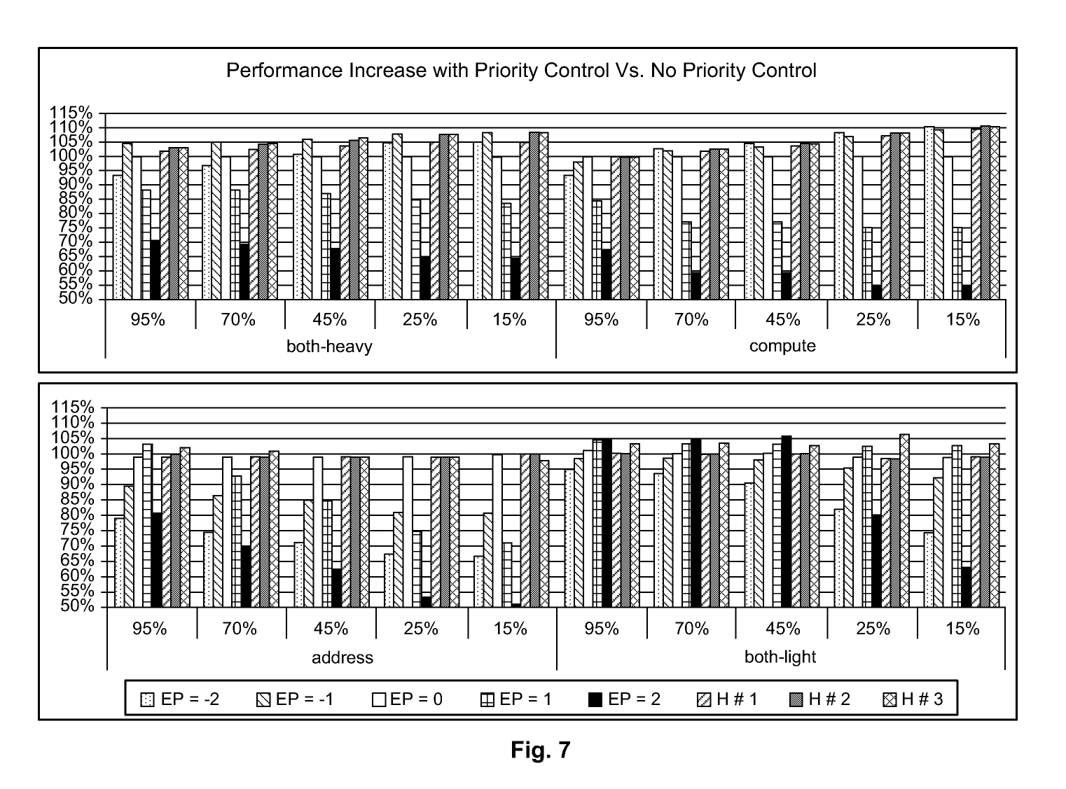

Referring to FIG. 7, a bar graph is provided that shows the results of experiments conducted to determine the performance increase with software-based priority control built into the main application thread and assist thread, compared to the performance without software-based priority control. The experiments were conducted on machines with POWER6 microprocessors with a 5 GHz clock rate. The operating system was AIX® (Advanced Interactive eXecutive) version 6. In order to test the concept on a large range of cases, synthetic kernels were used in the experiments. Each kernel had one loop with one delinquent load. These kernels were constructed with variations in two important factors for the assist thread prefetch system: the function unit usage by the application thread and assist thread; and the cache miss rate for delinquent loads. These two factors largely determine the execution timing and resource contention between the main application thread and the assist thread when running SMT threads.

All the operations in the main application thread can be partitioned into two groups: address calculation for delinquent loads (these operations may be part of the assist thread code); and computation work in the loop (these operations may be executed by the application thread only). For each of the two groups, many operations (e.g., about 10 cycles) may be assigned, or only a few operations (e.g., about 3 cycles) may be assigned. Using this approach, there are four combinations: both-heavy (both address and computation group have many operations); compute (the computation work has many operations while the address calculation has only a few operations); address (the address calculation has many operations while the computation work has only a few operations); and both-light (both address and computation groups have a few operations). Compared with both-heavy, both-light is more memory bound.

Another varying factor is the cache miss rate for the delinquent load. The instant inventors mixed random accesses and continuous accesses to achieve the desired L2 miss rate from the delinquent load. The instant inventors further programmed the kernels to exhibit miss rates from high to low of 95, 70, 45, 25, and 15 percent. These miss rates were chosen to represent the miss rates of delinquent loads found in real benchmarks. The miss rates were verified with a profiling tool provided with the XLC compiler. The data set was designed to be sufficiently large so that the L3 cache miss rate was close to the L2 cache miss rate. The different miss rates were combined with the different function unit usages, resulting in a total of 20 test cases, as shown in FIG. 7. These test cases covered a wide spectrum of scenarios encountered in real applications.

For all the effective priorities tested, effective priority 0 should have the same priority as the baseline except that the program code now includes extra instructions to set the priority. As indicated in FIG. 7, the performance for effective priority 0 reflects the overhead for setting the priority of the main application thread and the assist thread. As shown, effective priority 0 does not exhibit a notable slowdown which means that the disclosed technique for periodically setting the priority is efficient.

When the effective priority is −2 or −1, more decode cycles are assigned to the main application thread than to the assist thread. At these effective priorities, the test cases both-heavy and compute show performance improvement. This can be attributed to the fact that both of these cases have heavy function unit usage in the main application thread. Therefore, increasing the priority of the main application thread improves the performance. In the compute test case, there are fewer operations in the assist thread than the both-heavy test case. The both-heavy test case gets better performance where the effective priority is −1, while the compute test case gets better performance where the effective priority is −2.

When the effective priority is 1 or 2, more decode cycles are assigned to the assist thread. Using either of these effective priorities, the test case both-light shows performance improvement. The bottleneck for both-light is memory accesses and the data prefetch in the assist thread is on the critical path. Thus, increasing the assist thread's priority can improve performance.

It can be observed from FIG. 7 that changing the priority from the default can significantly reduce performance in some cases. This performance reduction can be up to fifty percent in some cases. This performance slowdown can be significant when the priority is changed in the wrong direction. However, in some cases, significant slowdown can also be the result of either increasing or decreasing the effective priority. This may be the result where the number of operations in the assist thread is close to that of the application thread. In such cases, an imbalance in the resource usage in either direction will hurt the total performance.

Heuristic 1 is a conservative rule. It can produce some performance improvement and typically never has negative impact. Heuristic 2 typically results in an improvement over Heuristic 1. It is slightly better than Heuristic 1 in some test cases. Both Heuristic 1 and Heuristic 2 are quite conservative in that they only require extra code in the assist thread and adjust the priority of the assist thread. The priority of the main application thread is not adjusted. However, Heuristics 1 and 2 cannot set the effective priority to 1 or 2. On the other hand, Heuristic 3 may be used to lower the priority of the main application thread, which can potentially have a negative impact on performance. To be safe, Heuristic 3 may be implemented such that it does not immediately lower the main application thread's priority the first time it detects that the assist thread is too slow. Heuristic 3 may be implemented such that it waits to see whether the “too slow” case occurs again and then takes action. The results in FIG. 7 show that Heuristic 3 may improve performance for the both-light test case. However, it also causes a slight slowdown for test cases with a low cache miss rate. During the course of the experiments, it was observed that up to a ten percent performance decrease may occur if the priority of the main application thread was promptly lowered when the assist thread was determined to be too slow.

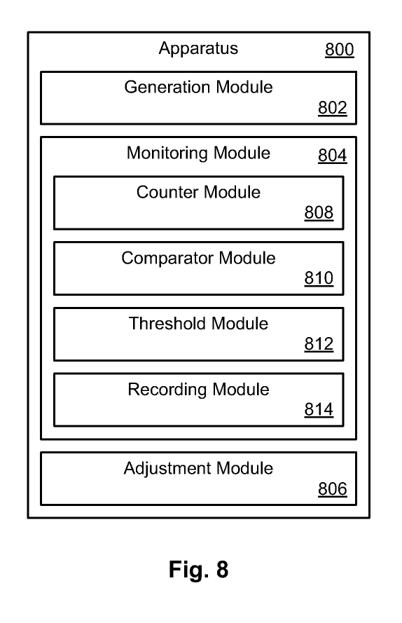

Referring to FIG. 8, a high-level block diagram of an apparatus 800 (such as a compiler 800) used to generate an assist thread for a main application thread, as well as embed software-based priority control instructions into the assist thread and main application thread, is illustrated. As shown, the apparatus 800 includes one or more modules. These modules may be implemented in hardware, software or firmware executable on hardware, or a combination thereof. The modules are presented only by way of example and are not intended to be limiting. Indeed, alternative embodiments may include more or fewer modules than those illustrated. Furthermore, it should be recognized that, in some embodiments, the functionality of some modules may be broken into multiple modules, or conversely, the functionality of several modules may be combined into a single module or fewer modules.

As shown, the apparatus 800 includes a generation module 802, a monitoring module 804, and an adjustment module 806. In general, the generation module 802 may be configured to generate an assist thread to prefetch data for a main application thread. To generate the assist thread, the apparatus 800 may use static analysis and dynamic profiling to determine which memory accesses to prefetch into cache. The memory accesses that cause the majority of cache misses during execution are referred to as delinquent loads. In certain embodiments, the generation module 802 attempts to remedy delinquent loads that are contained within loops. The generation module 802 may use a back-slicing algorithm to determine code sequence that will execute in the assist thread, and compute the memory addresses associated with the delinquent loads that are to be prefetched. The back-slicing algorithm may operate on a region of code containing the delinquent load, and this region may correspond to the containing loop nest, or some level of inner loops within the loop nest. The assist thread code may be configured such that it does not change the visible state of the application. The code generated for the application thread is minimally changed when an assist thread is being used. These changes include creating an assist thread once at the program entry point, activating the assist thread for prefetch at the entry to regions containing delinquent loads, and updating synchronization variables where applicable.

The monitoring module 804 may be configured to embed, within one or more of the assist thread and the main application thread, instructions to monitor the progress of the main application thread and the assist thread at runtime. For example, the monitoring module may modify the assist thread and/or main application thread to include the functionality described in FIGS. 1 and 2. The adjustment module 806 may be configured to embed, within one or more of the assist thread and main application thread, instructions to dynamically adjust the priority of the main application thread, the priority of the assist thread, or both, at runtime. For example, the adjustment module 806 may embed the functionality illustrated in FIGS. 3 and 4 into the main application thread and the assist thread respectively. These instructions may use software-controlled priority to substantially synchronize the progress of the main application thread and the assist thread.

In selected embodiments, the monitoring module 804 includes one or more of a counter module 808, a comparator module 810, a threshold module 812, and a recording module 814. The counter module 808 may be used to embed counters into the assist thread and main application thread to monitor the progress of each of the threads. A comparator module 810 may be used to embed instructions into the assist thread and/or main application thread to periodically compare the count values maintained by the counters. A threshold module 812 may embed instructions into the assist thread and/or main application thread to determine if the assist thread leads or trails the main application thread by too great a distance (i.e., the distance reaches a lower and/or upper threshold). A recording module 814, on the other hand, may embed instructions into the assist thread and/or main application thread to record, in a log, the numbers of times, amount, and/or frequency that the assist thread had to wait and/or jump ahead to stay synchronized with the main application thread. This information may be used by the assist thread and/or main application thread to adjust their priority in order to stay more synchronized.

The counters added to the assist thread and/or main application thread introduce some overhead into the assist thread and main application thread when they are periodically incremented and compared. Synchronizing the assist thread and main application thread by adjusting their priority also introduces additional overhead. To mitigate this overhead, one solution is to apply loop blocking to both the loop in the slice function and the corresponding loop in the application, and count iterations only in the outer blocked loop.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for optimizing data prefetch using assist threads, the method comprising:
executing a main application thread substantially simultaneously with an assist thread, the assist thread configured to prefetch data for the main application thread;
monitoring, at runtime, the progress of the main application thread and the assist thread; and
dynamically adjusting, at runtime, at least one of the priority of the main application thread and the priority of the assist thread to substantially synchronize the progress of the main application thread and the assist thread.

2. The method of claim 1, wherein executing the main application thread substantially simultaneously with the assist thread comprises executing the main application thread and the assist thread on the same processor core.

3. The method of claim 1, wherein executing the main application thread substantially simultaneously with the assist thread comprises executing the main application thread and the assist thread on different processor cores.

4. The method of claim 1, wherein monitoring the progress comprises using a first counter in the main application thread and a second counter in the assist thread to monitor the progress.

5. The method of claim 4, wherein monitoring the progress comprises comparing the first counter with the second counter.

6. The method of claim 5, further comprising adjusting at least one of the priority of the main application thread and the priority of the assist thread if the difference between the first counter and the second counter reaches a specified threshold value.

7. The method of claim 5, further comprising recording information in a log if the difference between the first counter and the second counter reaches a specified threshold value.

8. The method of claim 1, wherein dynamically adjusting comprises using software to dynamically adjust at least one of the priority of the main application thread and the priority of the assist thread.

9. A computer program product for optimizing data prefetch using assist threads, the computer program product comprising a computer-usable storage medium having computer-usable program code embodied therein, the computer-usable program code comprising:
computer-usable program code to generate an assist thread configured to prefetch data for a main application thread;
computer-usable program code to embed, within at least one of the assist thread and main application thread, instructions to monitor the progress of the main application thread and the assist thread at runtime; and
computer-usable program code to embed, within at least one of the assist thread and main application thread, instructions to dynamically adjust, at runtime, at least one of the priority of the main application thread and the priority of the assist thread to substantially synchronize the progress of the main application thread and the assist thread.

10. The computer program product of claim 9, wherein the main application thread and the assist thread execute on the same processor core.

11. The computer program product of claim 9, wherein the main application thread and the assist thread execute on different processor cores.

12. The computer program product of claim 9, wherein the instructions to monitor the progress comprise a first counter in the main application thread and a second counter in the assist thread.

13. The computer program product of claim 12, further comprising computer-usable program code to compare the first counter with the second counter.

14. The computer program product of claim 13, further comprising computer-usable program code to adjust at least one of the priority of the main application thread and the priority of the assist thread if the difference between the first counter and the second counter reaches a specified threshold value.

15. The computer program product of claim 13, further comprising computer-usable program code to record information in a log if the difference between the first counter and the second counter reaches a specified threshold value.

16. The computer program product of claim 9, wherein dynamically adjusting comprises using software to dynamically adjust at least one of the priority of the main application thread and the priority of the assist thread.

17. An apparatus for optimizing data prefetch using assist threads, the apparatus comprising:
a generation module to generate an assist thread configured to prefetch data for a main application thread;
a monitoring module to embed, within at least one of the assist thread and main application thread, instructions to monitor the progress of the main application thread and the assist thread at runtime; and
an adjustment module to embed, within at least one of the assist thread and the main application thread, instructions to dynamically adjust, at runtime, at least one of the priority of the main application thread and the priority of the assist thread to substantially synchronize the progress of the main application thread and the assist thread.

18. The apparatus of claim 17, wherein the main application thread and the assist thread are configured to execute on the same processor core.

19. The apparatus of claim 17, wherein the main application thread and the assist thread are configured to execute on different processor cores.

20. The apparatus of claim 17, wherein the monitoring module is further configured to embed a first counter in the main application thread and a second counter in the assist thread, to monitor the progress.

21. The apparatus of claim 20, wherein the monitoring module is further configured to embed instructions in at least one of the assist thread and the main application thread to compare the first counter with the second counter.

22. The apparatus of claim 21, wherein the adjustment module is further configured to embed instructions in at least one of the assist thread and main application thread to adjust at least one of the priority of the main application thread and the priority of the assist thread.

23. The apparatus of claim 21, wherein the monitoring module is further configured to embed instructions in at least one of the assist thread and the main application thread to record information in a log when the difference between the first counter and the second counter reaches a specified threshold value.

24. The apparatus of claim 17, wherein the instructions to dynamically adjust the priority use software to dynamically adjust at least one of the priority of the main application thread and the priority of the assist thread.

25. A system for optimizing data prefetch using assist threads, the system comprising:
a computer comprising a memory and at least one processor, the computer configured to:
execute a main application thread substantially simultaneously with an assist thread, the assist thread configured to prefetch data for the main application thread;
monitor, at runtime, the progress of the main application thread and the assist thread; and
dynamically adjust, at runtime, at least one of the priority of the main application thread and the priority of the assist thread to substantially synchronize the progress of the main application thread and the assist thread.
